(19) United States
(12) Patent Application Publication
(10) Pub. No.: US 2026/0167772 A1
(43) Pub. Date: Jun. 18, 2026

(54) POLYESTER, FORMED PRODUCT, AND METHOD FOR MANUFACTURING FORMED PRODUCT

(71) Applicant: SUMITOMO CHEMICAL COMPANY, LIMITED, Tokyo (JP)

(72) Inventor: Tomoki HIROHATA, Ibaraki (JP)

(21) Appl. No.: 19/412,142

(22) Filed: Dec. 8, 2025

(30) Foreign Application Priority Data
Dec. 13, 2024 (JP) 2024-218557

(51) Int. Cl. C08G 63/60; B29C 43/00; B29K 67/00; B29K 105/00

(52) U.S. Cl. CPC C08G 63/605; B29C 43/003; B29K 2067/04; B29K 2105/0079; B29K 2995/0006; B29K 2995/0007; B29K 2995/0016

(57) ABSTRACT

To provide a polyester having both good dielectric properties and excellent formability. A polyester comprising a first monomeric unit derived from a first monomer having a furan ring with two carbonyl groups attached and a second monomeric unit having a condensed aromatic ring, wherein the content of the first monomeric unit is 0.1 mol % or more and 40 mol % or less based on the total of all monomeric units, and the content of the second monomeric unit is 20 mol % or more based on the total of all monomeric units.

### TECHNICAL FIELD

The present disclosure is related to a polyester, a formed product, and a method for manufacturing the formed product.

### BACKGROUND ART

A liquid crystal polyester has been developed for various applications, such as electronic components, automobile components, OA parts, and heat-resistant tableware.

For example, Patent Literature 1 discloses an aromatic liquid crystal polyester film for a condenser comprising an aromatic liquid crystal polyester exhibiting an optical anisotropy when melted.

### CITATION LIST

### Patent Literature

Patent Literature 1: Japanese Patent Laid-Open No. 2002-359145

### SUMMARY OF INVENTION

### Problems to be Solved by Invention

In recent years, resins having high formability are in demand from the viewpoint of expanding to more diverse applications, suiting to more delicate parts, and the like. However, there have been cases of an uneven thickness, hole formation, and the like, at the time of film forming (especially, at the time of press forming) with conventional liquid crystal polyesters.

An object of the present disclosure is to provide a polyester having both good dielectric properties and excellent formability. In addition, an object of the present disclosure is to provide a formed product containing the said polyester and a method for manufacturing thereof.

### Means to Solve the Problems

The present disclosure provides, for example, the following.
[1] A polyester, comprising:
   a first monomeric unit derived from a first monomer having a furan ring with two carboxy groups attached; and
   a second monomeric unit having a condensed aromatic ring,
   wherein the content of the first monomeric unit is 0.1 mol % or more and 40 mol % or less based on the total of all monomeric units; and
   the content of the second monomeric unit is 20 mol % or more based on the total of all monomeric units.
[2] The polyester according to [1], wherein 90 mol % or more of monomeric units based on the total of all monomeric units is a monomeric unit having an aromatic ring.
[3] The polyester according to [1] or [2], further comprising a third monomeric unit having a benzene ring but no condensed aromatic ring or furan ring.
[4] The polyester according to [3], wherein the content of the third monomeric unit is 10 mol % or more and 75 mol % or less based on the total of all monomeric units.
[5] The polyester according to any one of [1] to [4], wherein the polyester has the 5% weight loss temperature of 450° C. or more.
[6] A formed product comprising the polyester according to any one of [1] to [5].
[7] A method for manufacturing a formed product, comprising a step of molding a raw molding material containing the polyester according to any one of [1] to [5] to obtain the molded product.
[8] The method for manufacturing according to [7], wherein the step is a step for press molding the raw material for molding.

### Effects of Invention

The present disclosure provides a polyester having both good dielectric properties and excellent formability. In addition, the present disclosure provides a formed product containing the said polyester and a method for manufacturing thereof.

### EMBODIMENTS FOR CARRYING OUT INVENTION

The embodiments suitable for the present disclosure are described in detail below.

The polyester according to the present embodiment contains a first monomeric unit derived from a first monomer having a furan ring with two carboxy groups attached and a second monomeric unit having a condensed aromatic ring. In the present embodiment, the content of the first monomeric unit is 0.1 mol % or more and 40 mol % or less based on the total of all monomeric units composing the polyester, and the content of the second monomeric unit is 20 mol % or more based on the total of all monomeric units composing the polyester.

The polyester according to the present embodiment has good dielectric properties and excellent formability. Reasons for producing such effects are not entirely clear, but it may be considered as the following.

The polyester according to the present embodiment contains 20 mol % or more of a second monomeric unit having a condensed aromatic ring, and therefore it has good dielectric properties and a high 5% weight loss temperature.

The polyester having a condensed aromatic ring is easy to orient by a strong interaction between the condensed aromatic rings causing a resin to spread unevenly at the time of forming (especially, at the time of press forming), and this can cause a defect, such as uneven thickness and hole formation. In the present embodiment, the polyester contains a first monomeric unit having a furan ring, and a weak interaction between the condensed aromatic ring and the furan ring interferes and weakens the interaction between the condensed aromatic rings; furthermore, a linearity of the polymer chain is broken by the furan ring causing the chains to become entangled more easily. As a result, the resin spreads uniformly at the time of forming (especially, at the time of press forming), and defects, such as an uneven thickness and hole formation, are presumed to occur less frequently.

In addition, while the polyester having a condensed aromatic ring has an aspect of exhibiting good dielectric properties (in some cases, even higher 5% weight loss temperature) by the interaction between the condensed aromatic rings, it is presumed that the introduction of a furan ring in the present embodiment eases the rigidity of the polymer chain that is caused by the interaction between the condensed aromatic rings and suppresses the reduction in dielectric properties (in some cases, even higher 5% weight loss temperature) by interfering with a weak interaction between the condensed aromatic ring and the furan ring resulting in the polyester having both good dielectric properties (in some cases, even higher 5% weight loss temperature) and excellent formability.

The polyester according to the present embodiment may be a polyester that exhibits a liquid crystallinity in a molten state (that is, a liquid crystal polyester). The polyester according to the present embodiment may be one type of polymer, or it may be a mixture of two or more polymers. If the polyester is a mixture of two or more polymers, the content of each monomeric unit described later represents a total amount of each monomeric unit in the mixture. Also, if the polyester is a mixture of two or more polymers, a parameter related to the polyester as described later represents a parameter of the mixture (a parameter measured by using the mixture). Furthermore, a total of all monomeric units represents a total of the monomeric units composing each polymer.

The polyester according to the present embodiment has a structural unit (monomeric unit) derived from a raw material monomer. The main monomeric unit (for example, a monomeric unit of 90 mol % or more, 95 mol % or more, or 99 mol % or more, preferably all monomeric units, based on the total of all monomeric units) in the polyester may be a monomeric unit having an aromatic ring, that is, a monomeric unit derived from an aromatic compound. A polyester wherein the monomeric units are all derived from an aromatic compound is also known as a fully aromatic polyester. A liquid crystal polyester wherein the monomeric units are all derived from an aromatic compound is also known as a fully aromatic liquid crystal polyester.

A phrase “derived from” in the present specification means that while the chemical structure of the functional group of a raw material monomer contributing to a polymerization changes, no other structural change occurs in the monomeric unit of a polyester formed by the polymerization of the raw material monomers. The phrase “derived from” herein is a concept that also includes a situation with a polymerizable derivative of a raw material monomer (for example, a compound wherein a functional group of the raw material monomer contributing to the polymerization is converted to another polymerizable group).

An aromatic compound is a compound having an aromatic ring. An aromatic compound suitable as a raw material monomer may have an aromatic ring and two or more polymerizable groups attached to the aromatic ring (for example, a hydroxy group, an amino group, or a carboxy group, preferably a hydroxy group or a carboxy group).

The aromatic compound may be, for example, a compound represented by the following formula (1-1) (hereinafter, also referred to as a monomer (1-1)), a compound represented by the following formula (1-2) (hereinafter, also referred to as a monomer (1-2)), or a compound represented by the following formula (1-3) (hereinafter, also referred to as a monomer (1-3)):

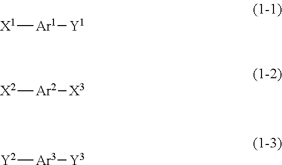

wherein Ar¹ and Ar² each independently represent a phenylene group, a biphenylene group, a condensed polycyclic aromatic hydrocarbon group, or a group represented by the formula (Z-1); Ar³ represents a furandiyl group, a phenylene group, a biphenylene group, a condensed polycyclic aromatic hydrocarbon group, or a group represented by the formula (Z-1); some or all of the hydrogen atoms that Ar¹, Ar², and Ar³ have may be substituted with a halogen atom, an alkyl group, or an aryl group; X¹, X², and X³ each independently represent a hydroxy group or an amino group; and Y¹, Y², and Y³ represent a carboxy group.

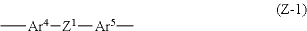

wherein Ar⁴ and Ar⁵ each independently represent a phenylene group or a condensed polycyclic aromatic hydrocarbon group; and Z¹ represents an oxygen atom (—O—), a sulfur atom (—S—), a carbonyl group (—CO—), a sulfonyl group (—SO₂—), or an alkanediyl group.

The monomeric unit derived from the aromatic compound may be, for example, a monomeric unit represented by the following formula (2-1) (hereinafter, also referred to as a monomeric unit (2-1)), a structural unit represented by the following formula (2-2) (hereinafter, also referred to as a monomeric unit (2-2)), or a structural unit represented by the following formula (2-3) (hereinafter, also referred to as a monomeric unit (2-3)). It can be said that the monomeric unit (2-1) is a monomeric unit derived from the monomer (1-1); the monomeric unit (2-2) is a monomeric unit derived from the monomer (1-2); and the monomeric unit (2-3) is a monomeric unit derived from the monomer (1-3):

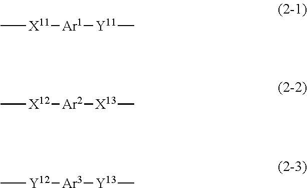

wherein Ar¹, Ar², and Ar³ are the same as above; X¹¹, X¹², and X¹³ each independently represent an oxygen atom (—O—) or an imino group (—NH—); and Y¹¹, Y¹², and Y¹³ represent a carbonyl group (—CO—).

The phenylene group may be, for example, a 1,4-phenylene group or a 1,3-phenylene group, and a 1,4-phenylene group is preferable.

The biphenylene group may be, for example, a 4,4′-biphenylene group.

A condensed polycyclic aromatic hydrocarbon group is a group with two hydrogen atoms removed from a condensed polycyclic aromatic hydrocarbon. Examples of the condensed polycyclic aromatic hydrocarbon include naphthalene, anthracene, phenanthrene, tetracene, pyrene, triphenylene, perylene, and fluorene; among these, naphthalene is preferable from the viewpoint of availability and cost.

The condensed polycyclic aromatic hydrocarbon group may be a naphthalene group. The naphthalene group may be, for example, a 2,6-naphthalene group, a 2,7-naphthalene group, a 1,4-naphthalene group, a 1,5-naphthalene group, a 1,6-naphthalene group, or a 1,5-naphthalene group, and a 2,6-naphthalene group is preferable.

A furandiyl group is a group with two hydrogen atoms removed from a furan. The furandiyl group may be, for example, a 2,5-furandiyl group, a 2,4-furandiyl group, a 2,3-furandiyl group, or a 3,4-furandiyl group, and a 2,5-furandiyl group is preferable.

Examples of a halogen atom as a substituent include a fluorine atom, a chlorine atom, a bromine atom, and an iodine atom.

The alkyl group as a substituent may be linear, branched, or cyclic. The alkyl group may be, for example, an alkyl group having 1 to 10 carbon atoms. Examples of the alkyl group include a methyl group, an ethyl group, an n-propyl group, an isopropyl group, an n-butyl group, an isobutyl group, an s-butyl group, a t-butyl group, an n-hexyl group, a 2-ethylhexyl group, an n-octyl group, and an n-decyl group.

The aryl group as a substituent may be monocyclic, or it may be a condensed ring. The aryl group may be, for example, an aryl group having 6 to 20 carbon atoms. Examples of the aryl group include a phenyl group, an o-tolyl group, an m-tolyl group, a p-tolyl group, a 1-naphthyl group, and a 2-naphthyl group. The aryl group may be a group with a hydrogen atom of the aromatic ring substituted with an alkyl group, as in a tolyl group.

The number of substituents that Ar¹, Ar², and Ar³ have may be, for example, 0 to 2, or it may be 0 or 1, or it may be 0.

The alkanediyl group in Z¹ may be linear or branched. The alkanediyl group may be an alkanediyl group having 1 to 10 carbon atoms. Examples of the alkanediyl group include a methylene group, an ethanediyl group, a propanediyl group (for example, a propane-2,2-diyl group), a butanediyl group, and an octanediyl group (for example, an octane-3,3-diyl group).

X¹, X², and X³ are preferably a hydroxy group, and X¹¹, X¹², and X¹³ are preferably an oxygen atom (—O—). That is, the monomer (1-1) may be aromatic hydroxycarboxylic acid, and the monomer (1-2) may be aromatic diol. The monomer (1-3) may be aromatic dicarboxylic acid.

The polyester according to the present embodiment contains a first monomeric unit derived from a first monomer having a furan ring with two carboxy groups attached. The first monomeric unit may be a monomeric unit having a furan ring with two carbonyl groups attached, or it may be a monomeric unit that is derived from the first monomer and has a structure with the furan ring opened, or it may be a monomeric unit having a furan-derived pyrone ring.

The first monomeric unit may be a monomeric unit corresponding to the monomeric unit (2-3). The first monomeric unit may be, for example, a monomeric unit (2-3) with Ar³ as a furandiyl group (preferably, a 2,5-furandiyl group) (hereinafter, also referred to as a monomeric unit (2-3-1)).

The first monomer may be a monomer corresponding to the monomer (1-3). The first monomer may be, for example, a monomer (1-3) with Ar³ as a furandiyl group (preferably, a 2,5-furandiyl group) (hereinafter, also referred to as a monomer (1-3-1)).

Examples of the first monomer include 2,5-furandicarboxylic acid, 2,4-furandicarboxylic acid, 2,3-furandicarboxylic acid, and 3,4-furandicarboxylic acid, and 2,5-furandicarboxylic acid is preferable.

The polyester according to the present embodiment further contains a second monomeric unit having a condensed aromatic ring.

Examples of the condensed aromatic ring that the second monomeric unit has include a naphthalene ring, an anthracene ring, a phenanthrene ring, a tetracene ring, a pyrene ring, a triphenylene ring, a perylene ring, and a fluorene ring; among these, the naphthalene ring is preferable from the viewpoint of availability and cost.

The second monomeric unit may be a monomeric unit corresponding to the monomeric unit (2-1), or it may be a monomeric unit corresponding to the monomeric unit (2-2), or it may be a monomeric unit corresponding to the monomeric unit (2-3). The second monomeric unit may be, for example, a monomeric unit corresponding to the monomeric unit (2-1) or the monomeric unit (2-3).

The second monomeric unit may be, for example, a monomeric unit (2-1) with Ar¹ as a condensed polycyclic aromatic hydrocarbon group (hereinafter, also referred to as a monomeric unit (2-1-2)), or it may be a monomeric unit (2-2) with Ar² as a condensed polycyclic aromatic hydrocarbon group (hereinafter, also referred to as a monomeric unit (2-2-2)), or it may be a monomeric unit (2-3) with Ar³ as a condensed polycyclic aromatic hydrocarbon group (hereinafter, also referred to as a monomeric unit (2-3-2)). The condensed polycyclic aromatic hydrocarbon group in the second monomeric unit is preferably a naphthalene group, more preferably a 2,6-naphthalene group.

The second monomeric unit may also be a monomeric unit derived from the second monomer having a condensed aromatic ring.

The second monomer may be a monomer corresponding to the monomer (1-1), or it may be a monomer corresponding to the monomer (1-2), or it may be a monomer corresponding to the monomer (1-3). The second monomer may be, for example, a monomer corresponding to the monomer (1-1) or the monomer (1-3).

The second monomer may be, for example, a monomer (1-1) with Ar¹ as a condensed polycyclic aromatic hydrocarbon group (hereinafter, also referred to as a monomer (1-1-2)), or it may be a monomer (1-2) with Ar² as a condensed polycyclic aromatic hydrocarbon group (hereinafter, also referred to as a monomer (1-2-2)), or it may be a monomer (1-3) with Ar³ as a condensed polycyclic aromatic hydrocarbon group (hereinafter, also referred to as a monomer (1-3-2)). The condensed polycyclic aromatic hydrocarbon group in the second monomer is preferably a naphthalene group, more preferably a 2,6-naphthalene group.

Examples of the second monomer include 2-hydroxy-6-naphthoic acid, 2,6-naphthalenedicarboxylic acid, 2,6-dihydroxynaphthalene, 1,5-dihydroxynaphthalene, 2-hydroxy-3-naphthoic acid, 1-hydroxy-5-naphthoic acid, and 2,7-naphthalenediol. The second monomer is preferably 2-hydroxy-6-naphthoic acid or 2,6-naphthalenedicarboxylic acid.

The polyester according to the present embodiment may further contain a third monomeric unit having a benzene ring but no condensed aromatic ring or furan ring.

The third monomeric unit may be a monomeric unit corresponding to the monomeric unit (2-1), or it may be a monomeric unit corresponding to the monomeric unit (2-2), or it may be a monomeric unit corresponding to the monomeric unit (2-3).

The third monomeric unit may be, for example, a monomeric unit (2-1) with Ar¹ as a phenylene group, a biphenylene group, or a group represented by the formula (Z-1) (provided that Ar⁴ and Ar⁵ are phenylene groups) (hereinafter, also referred to as a monomeric unit (2-1-3)), or it may be a monomeric unit (2-2) with Ar² as a phenylene group, a biphenylene group, or a group represented by the formula (Z-1) (provided that Ar⁴ and Ar⁵ are phenylene groups) (hereinafter, also referred to as a monomeric unit (2-2-3)), or it may be a monomeric unit (2-3) with Ar³ as a phenylene group, a biphenylene group, or a group represented by the formula (Z-1) (provided that Ar⁴ and Ar⁵ are phenylene groups) (hereinafter, also referred to as a monomeric unit (2-3-3)). Ar¹, Ar², and Ar³ in the third monomeric unit are preferably a phenylene group or a biphenylene group, more preferably a 1,4-phenylene group, a 1,3-phenylene group, or a 4,4′-biphenylene group, even more preferably a 1,4-phenylene group or a 4,4′-biphenylene group.

The third monomeric unit may be a monomeric unit derived from a third monomeric unit having a benzene ring but no condensed aromatic ring or furan ring.

The third monomer may be a monomer corresponding to the monomer (1-1), or it may be a monomer corresponding to the monomer (1-2), or it may be a monomer corresponding to the monomer (1-3).

The third monomer may be, for example, a monomer (1-1) with Ar¹ as a phenylene group, a biphenylene group, or a group represented by the formula (Z-1) (provided that Ar⁴ and Ar⁵ are phenylene groups) (hereinafter, also referred to as a monomer (1-1-3)), or it may be a monomer (1-2) with Ar² as a phenylene group, a biphenylene group, or a group represented by the formula (Z-1) (provided that Ar⁴ and Ar⁵ are phenylene groups) (hereinafter, also referred to as a monomer (1-2-3)), or it may be a monomer (1-3) with Ar³ as a phenylene group, a biphenylene group, or a group represented by the formula (Z-1) (provided that Ar⁴ and Ar⁵ are phenylene groups) (hereinafter, also referred to as a monomer (1-3-3)). Ar¹, Ar², and Ar³ in the third monomer are preferably a phenylene group or a biphenylene group, more preferably a 1,4-phenylene group, a 1,3-phenylene group, or a 4,4′-biphenylene group, even more preferably a 1,4-phenylene group or a 4,4′-biphenylene group.

Examples of the third monomer include p-hydroxybenzoic acid, m-hydroxybenzoic acid, hydroquinone, resorcinol, 4,4′-dihydroxybiphenyl, terephthalic acid, isophthalic acid, and 4,4′-biphenyldicarboxylic acid. The third monomer is preferably p-hydroxybenzoic acid, hydroquinone, 4,4′-dihydroxybiphenyl, terephthalic acid, or isophthalic acid.

The polyester according to the present embodiment may be composed of, for example, the monomeric unit (2-1), or it may be composed of the monomeric unit (2-1), the monomeric unit (2-2), and the monomeric unit (2-3).

If the polyester according to the present embodiment contains the monomeric unit (2-1), the monomeric unit (2-2), and the monomeric unit (2-3), the content of the monomeric unit (2-1) may be, for example, 10 mol % or more, or it may be 20 mol % or more, 30 mol % or more, 40 mol % or more, 45 mol % or more, or 50 mol % or more, based on the total of all monomeric units. In addition, if the polyester according to the present embodiment contains the monomeric unit (2-1), the monomeric unit (2-2), and the monomeric unit (2-3), the content of the monomeric unit (2-1) may be, for example, 99 mol % or less, or it may be 98 mol % or less, 95 mol % or less, 90 mol % or less, 85 mol % or less, 80 mol % or less, or 75 mol % or less, based on the total of all monomeric units.

If the polyester according to the present embodiment contains the monomeric unit (2-1), the monomeric unit (2-2), and the monomeric unit (2-3), the contents of the monomeric unit (2-2) and the monomeric unit (2-3) may be almost identical (for example, a difference of 3 mol % or less, 1 mol % or less, 0.5 mol % or less, or 0.1 mol % or less).

If the polyester according to the present embodiment contains the monomeric unit (2-1), the monomeric unit (2-2), and the monomeric unit (2-3), the total content of the monomeric unit (2-2) and the monomeric unit (2-3) may be, for example, 0.2 mol % or more, or it may be 1 mol % or more, 2 mol % or more, 5 mol % or more, 10 mol % or more, 15 mol % or more, 20 mol % or more, or 25 mol % or more, based on the total of all monomeric units. In addition, if the polyester according to the present embodiment contains the monomeric unit (2-1), the monomeric unit (2-2), and the monomeric unit (2-3), the total content of the monomeric unit (2-2) and the monomeric unit (2-3) may each be, for example, 90 mol % or less, or it may be 80 mol % or less, 70 mol % or less, 60 mol % or less, 55 mol % or less, or 50 mol % or less, based on the total of all monomeric units.

The content of the first monomeric unit may be 0.1 mol % or more based on the total of all monomeric units, or it may be 0.3 mol % or more, 0.5 mol % or more, 1 mol % or more, 2 mol % or more, or 5 mol % or more, from the viewpoint of obtaining the abovementioned effects by the furan ring more significantly. In addition, the content of the first monomeric unit may be 40 mol % or less based on the total of all monomeric units, or it may be 30 mol % or less, 20 mol % or less, 15 mol % or less, 10 mol % or less, or 5 mol % or less, from the viewpoint of further improving the dielectric properties and heat resistance.

The content of the second monomeric unit may be 20 mol % or more based on the total of all monomeric units, or it may be 25 mol % or more, 30 mol % or more, 35 mol % or more, 40 mol % or more, 45 mol % or more, 50 mol % or more, or 55 mol % or more, from the viewpoint of further improving the dielectric properties. It should be noted that in the conventional polyester, the higher the content of the condensed aromatic ring, the more likely a defect caused by the abovementioned strong interaction between the condensed aromatic rings may occur at the time of forming; but in the polyester according to the present embodiment, even if the content of the condensed aromatic ring is high (the content of the second monomeric unit is high), excellent formability is achieved as a result of combining with the first monomeric unit. In addition, the content of the second monomeric unit may be, for example, 99 mol % or less, or it may be 95 mol % or less, 90 mol % or less, 85 mol % or less, 80 mol % or less, or 75 mol % or less, based on the total of all monomeric units.

The content of the second monomeric unit may be, for example, a difference obtained by subtracting contents of the first monomeric unit and the third monomeric unit from the total of all monomeric units. That is, the upper limit for the content of the second monomeric unit may be, for example, a value such that the upper limit for the content of the second monomeric unit, the lower limit for the content of the first monomeric unit, and the lower limit for the content of the third monomeric unit add up to 100 mol %.

If the polyester according to the present embodiment contains the third monomeric unit, the content of the third monomeric unit may be, for example, 10 mol % or more based on the total of all monomeric units, or it may be 15 mol % or more, 20 mol % or more, or 25 mol % or more, from the viewpoint of fluidity. In addition, the content of the third monomeric unit may be, for example, 75 mol % or less, or it may be 70 mol % or less, 65 mol % or less, or 60 mol % or less, based on the total of all monomeric units.

The content of the third monomeric unit may be, for example, a difference obtained by subtracting contents of the first monomeric unit and the second monomeric unit from the total of all monomeric units. That is, the upper limit for the content of the third monomeric unit may be, for example, a value such that the upper limit for the content of the third monomeric unit, the lower limit for the content of the first monomeric unit, and the lower limit for the content of the second monomeric unit add up to 100 mol %.

The total amount of the first, the second, and the third monomeric units in the polyester according to the present embodiment may be, for example, 90 mol % or more, 95 mol % or more, 97 mol % or more, or 99 mol % or more, or it may be 100 mol %, based on the total of all monomeric units.

In the present specification, the number of each monomeric unit that the polyester has is obtained by the analysis method disclosed in Japanese Patent Laid-Open No. 2000-19168. Specifically, the polyester is reacted with a lower alcohol in a supercritical state to depolymerize, and the depolymerized product (a monomer that derives each monomeric unit) is quantified by liquid chromatography to calculate a number of each monomeric unit based on all monomeric units.

The flow starting temperature of the polyester according to the present embodiment may be, for example, 200° C. or more, or it may be 220° C. or more, 240° C. or more, or 245° C. or more, from the viewpoint of further improving the shape stability under high temperature environment. In addition, the flow starting temperature of the polyester according to the present embodiment may be, for example, 360° C. or less, or it may be 330° C. or less, 325° C. or less, or 320° C. or less, from the viewpoint of easing the temperature condition at the time of forming.

In the present specification, the flow starting temperature of the polyester is measured using a flow tester whereby the polyester is melted and extruded through a nozzle with an inner diameter of 1 mm and a length of 10 mm while increasing the temperature at a rate of 4° C./min under a load of 9.8 MPa (100 kg/cm²), and the temperature exhibiting a polyester viscosity of 4800 Pa·s (48000 P) is taken as the flow starting temperature of the polyester.

The 5% weight loss temperature of the polyester according to the present embodiment may be, for example, 450° C. or more, or it may be 455° C. or more, 460° C. or more, or 465° C. or more. It can be said that the polyester having a high 5% weight loss temperature has excellent heat resistance. The upper limit for the 5% weight loss temperature of the polyester according to the present embodiment is not limited, and may be, for example, 550° C. or less, or 500° C. or less.

The dielectric loss tangent of the polyester according to the present embodiment at a frequency of 20 GHz may be, for example, 0.0050 or less, or it may be 0.0040 or less, 0.0030 or less, or 0.0015 or less. It can be said that the polyester having a low dielectric loss tangent has better dielectric properties. The lower limit for the dielectric loss tangent of the polyester according to the present embodiment at a frequency of 20 GHz is not limited, and may be, for example, 0.0005 or more, or 0.0010 or more.

The relative permittivity of the polyester according to the present embodiment at a frequency of 20 GHz may be, for example, 4.0 or less, or it may be 3.5 or less, 3.3 or less, or 3.2 or less. A low relative permittivity tends to result in better insulating properties. The relative permittivity of the polyester according to the present embodiment at a frequency of 20 GHz may be, for example, 2.5 or more, or it may be 3.0 or more, 3.3 or more, or 3.4 or more. A high relative permittivity tends to result in a substance being polarized more easily.

In the present specification, the dielectric loss tangent and the relative permittivity of the polyester at a frequency of 20 GHz are measured by the following method.

A vector network analyzer (for example, N5290A manufactured by Keysight Technologies, Inc.) and a split cylinder resonator (for example, CR710 manufactured by EM labs, Inc.) are used to measure a dielectric loss tangent of a test piece of a liquid crystal polyester at 23° C., 50% relative humidity, and 20 GHz.

The polyester according to the present embodiment can be manufactured by polymerizing a raw material monomer corresponding to the monomer that composes the polyester. A polymerization method may be appropriately selected from known methods. The polyester according to the present embodiment may be manufactured, for example, in accordance with the method disclosed in Japanese Patent No. 6439027.

The polyester according to the present embodiment can be suitably used as a raw molding material for molding to obtain a formed product. The polyester may be used as, for example, a pellet, a micro powder, and the like.

The polyester according to the present embodiment may be used as a resin composition such that the polyester is mixed with another component (a resin composition).

The resin composition may contain one or more types of resins other than the polyester according to the present embodiment. Examples of the said resin include a liquid crystal polyester, polyolefin, cyclic polyolefin, polyvinyl chloride, polysulfone, a methacrylic resin, a polyphenylene ether resin, a polyacetal resin, a polyamide resin, an imide resin, a cellulose resin, a polyether ether ketone resin, a fluororesin, a polycarbonate resin, a styrene resin, and a thermosetting resin.

The resin composition may further contain an inorganic filler, a colorant, a dispersant, a plasticizer, an antioxidant, a curing agent, a flame retardant, a heat stabilizer, a UV absorber, an antistatic agent, a surfactant, a lubricant, a mold release agent, and the like.

The resin composition may be suitably used as a raw molding material for molding to obtain a formed product. The resin composition may be used as, for example, a pellet, a micro powder, and the like.

### (Formed Product)

The formed product according to the present embodiment may be a formed product containing the abovementioned polyester according to the present embodiment, or it may be a formed product containing the abovementioned resin composition.

The formed product according to the present embodiment may be obtained by molding a raw molding material for forming containing the polyester according to the present embodiment.

A forming method is not particularly limited, but a melt forming method is preferable. Examples of the melt forming method include an injection molding method, an extrusion method, a compression molding method, a blow molding method, a vacuum forming method, a foam molding, and a press forming. Among these, the press forming is preferable from the viewpoint of obtaining the abovementioned effects more significantly.

The conditions for the press forming are not particularly limited. The forming temperature at the time of press forming is preferably higher than the flow starting temperature of the polyester, and it may be, for example, 220 to 370° C., or it may be 240 to 350° C.

The difference between the forming temperature at the time of press forming and the flow starting temperature of the polyester (the forming temperature subtracted by the flow starting temperature) may be, for example, 3° C. or more, or it may be 5° C. or more, 10° C. or more, or 15° C. or more. In addition, the difference between the forming temperature at the time of press forming and the flow starting temperature of the polyester (the forming temperature subtracted by the flow starting temperature) may be, for example, 50° C. or less, or it may be 40° C. or less, 30° C. or less, or 20° C. or less.

The formed product according to the present embodiment may be, for example, a film, a connector, a socket, relay parts, a coil bobbin, an optical pickup, an oscillator, a semiconductor package, an IC tray, a wafer carrier, parts for home appliances, lighting fixture components, acoustic product components, a ferrule for an optical cable, telephone parts, facsimile parts, modem parts, a separation claw, a heater holder, an impeller, a fan gear, a gear, a bearing, motor parts, a motor case, engine parts, parts in an engine room, electrical components, automotive interior parts, a microwaveable pot, heat-resistant tableware, a flooring material, a wall material, a beam, a pillar, a roofing material, aircraft parts, aerospace parts, spacecraft parts, a nuclear reactor, components for marine facilities, a cleaning tool, optical equipment parts, valves, pipes, nozzles, filters, components for medical devices, medical materials, sensor parts, sanitary products, sports equipment, recreational equipment, and the like.

The formed product according to the present embodiment may be a film from the viewpoint of obtaining the abovementioned effects more significantly.

The thickness of the film is not particularly limited, and it may be, for example, 1000 μm or less, or it may be 300 μm or less, 250 μm or less, or 200 μm or less. In a thin film, a defect caused by an interaction between the condensed aromatic rings is more likely to occur at the time of forming, and so the abovementioned effects are obtained more significantly with the polyester according to the present embodiment. The thickness of the film may be, for example, 10 μm or more, or it may be 20 μm or more, or 50 μm or more.

The embodiments suitable for the present disclosure were described as above, but the present disclosure is not limited to the abovementioned embodiments.

### EXAMPLES

The present disclosure is explained in more detail below with examples, but the present disclosure is not limited to these examples.

### Example A-1

Into a reactor equipped with a stirring device, a torque meter, a nitrogen gas inlet tube, a thermometer, and a reflux condenser, 188.2 g (1.0 mol) of 2-hydroxy-6-naphthoic acid, 62.1 g (0.33 mol) of 4,4′-dihydroxybiphenyl, 41.5 g (0.25 mol) of terephthalic acid, 13.0 g (0.08 mol) of 2,5-furandicarboxylic acid, 195.7 g (1.92 mol) of acetic anhydride were placed, and 0.030 g of 1-methylimidazole was added as a catalyst. The gas in the reactor was replaced with nitrogen gas completely, then the temperature was increased to 145° C. over a period of 30 minutes while stirring in a nitrogen gas stream, and the mixture was refluxed for 1 hour while maintaining the temperature.

Then, while evaporating flowing-out by-product acetic acid and unreacted acetic anhydride, the temperature was increased to 310° C. over a period of 3 hours and 30 minutes; the reaction was considered complete when the predetermined torque increase was observed; and the contents inside the reactor were removed. The flow starting temperature of the obtained solid was 272° C.

The obtained solid was cooled to room temperature and was pulverized to obtain a powder. The obtained powder was heated from room temperature to 260° C. over a period of 1 hour under nitrogen atmosphere, heated from 260° C. to 290° C. over a period of 3 hours and held at 290° C. for 5 hours to proceed with the polymerization reaction in solid phase to obtain a polyester (A-1). The flow starting temperature of the obtained polyester (A-1) was 327° C. The flow starting temperature was measured by the following method. Also, for the obtained polyester (A-1), the 5% weight loss temperature was measured, and formability and dielectric properties were evaluated by the following methods. The results are shown in Table 1.

### <Measurement of Flow Starting Temperature>

A flow tester (“model CFT-500” manufactured by Shimadzu Corporation) was used for measurement. Specifically, about 2 g of sample was filled in a capillary rheometer attached with a die with an inner diameter of 1 mm and a length of 10 mm. Then, the sample was extruded from a nozzle while increasing the temperature at a rate of 4° C./min under a load of 9.8 MPa (100 kg/cm²), and the temperature exhibiting a melt viscosity of 4800 Pa·s (48000 P) was measured as the flow starting temperature.

### <Measurement of 5% Weight Loss Temperature>

Using “DTG-60A” manufactured by Shimadzu Corporation, 10 mg of sample was heated under the conditions of nitrogen atmosphere, the starting temperature of 30° C., and the temperature increase rate of 10° C./min, to obtain a temperature at which the weight loss rate becomes 5%.

### <Evaluation of Formability>

Using a mold with a thickness of 0.2 mm, the sample was hot pressed by a single-action compression molding machine model NF-37 (manufactured by Shinto Metal Industries, Ltd) under the conditions of a temperature of the flow starting temperature plus 20° C. and a setting pressure of 0.1 MPa to manufacture a formed product.

Any presence or absence of holes on the formed product (number of holes) and the difference between the maximum and the minimum values of the measured values for the thicknesses at any five points on the formed product (that is, uneven thickness) were taken as evaluation criteria to evaluate formability. Specifically, the sample was evaluated as “A” if no holes and an uneven thickness of less than 30 μm; “B” if no holes and an uneven thickness of 30 μm or more but less than 50 μm; “C” if one or more and less than 10 holes and an uneven thickness of 30 μm or more but less than 50 μm; and “D” if 10 or more holes and an uneven thickness of 50 μm or more.

### <Evaluation of Dielectric Properties>

Using a mold with a thickness of 0.2 mm, the sample was hot pressed by a single-action compression molding machine model NF-37 (manufactured by Shinto Metal Industries, Ltd) under the conditions of a temperature of the flow starting temperature plus 20° C. and a setting pressure of 0.1 MPa to manufacture a formed product.

A vector network analyzer (N5290A manufactured by Keysight Technologies, Inc.) and a split cylinder resonator (CR710 manufactured by EM labs, Inc.) were used to measure a relative permittivity and a dielectric loss tangent of the obtained formed product at a frequency of 20 Hz. The measurement was performed in the environment of 23° C. with 50% relative humidity.

### Example A-2

Except for changing the components added to the reactor to 172.5 g (0.92 mol) of 2-hydroxy-6-naphthoic acid, 42.5 g (0.39 mol (0.01 mol used in excess)) of hydroquinone, 63.1 g (0.29 mol) of 2,6-naphthalenedicarboxylic acid, 13.0 g (0.08 mol) of 2,5-furandicarboxylic acid, 198.3 g (1.94 mol) of acetic anhydride, and 0.030 g of 1-methylimidazole, a solid powder was obtained in the same way as Example A-1.

Then, the obtained powder was heated from room temperature to 250° C. over a period of 1 hour under nitrogen atmosphere, heated from 250° C. to 280° C. over a period of 3 hours and held at 280° C. for 5 hours to proceed with the polymerization reaction in solid phase to obtain a polyester (A-2). The flow starting temperature of the obtained polyester (A-2) was 324° C. The obtained polyester (A-2) was evaluated in the same way as Example A-1. The results are shown in Table 1.

### Example A-3

Except for changing the components added to the reactor to 188.2 g (1.0 mol) of 2-hydroxy-6-naphthoic acid, 18.9 g (0.17 mol) of hydroquinone, 31.0 g (0.17 mol) of 4,4′-dihydroxybiphenyl, 52.0 g (0.33 mol) of 2,5-furandicarboxylic acid, 196.8 g (1.93 mol) of acetic anhydride, and 0.030 g of 1-methylimidazole, a solid powder was obtained in the same way as Example A-1.

Then, the obtained powder was heated from room temperature to 190° C. over a period of 1 hour under nitrogen atmosphere, heated from 190° C. to 220° C. over a period of 3 hours and held at 220° C. for 5 hours to proceed with the polymerization reaction in solid phase to obtain a polyester (A-3). The flow starting temperature of the obtained polyester (A-3) was 239° C. The obtained polyester (A-3) was evaluated in the same way as Example A-1. The results are shown in Table 1.

### Example A-4

Except for changing the components added to the reactor to 125.5 g (0.67 mol) of 2-hydroxy-6-naphthoic acid, 28.4 g (0.26 mol (0.01 mol used in excess)) of hydroquinone, 46.6 g (0.25 mol) of 4,4′-dihydroxybiphenyl, 78.0 g (0.50 mol) of 2,5-furandicarboxylic acid, 197.4 g (1.93 mol) of acetic anhydride, and 0.028 g of 1-methylimidazole, a solid powder was obtained in the same way as Example A-1.

Then, the obtained powder was heated from room temperature to 210° C. over a period of 1 hour under nitrogen atmosphere, heated from 210° C. to 240° C. over a period of 3 hours and held at 240° C. for 5 hours to proceed with the polymerization reaction in solid phase to obtain a polyester (A-4). The flow starting temperature of the obtained polyester (A-4) was 244° C. The obtained polyester (A-4) was evaluated in the same way as Example A-1. The results are shown in Table 1.

### Example A-5

Except for changing the components added to the reactor to 150.5 g (0.80 mol) of 2-hydroxy-6-naphthoic acid, 4.6 g (0.03 mol) of p-hydroxybenzoic acid, 77.6 g (0.42 mol) of 4,4′-dihydroxybiphenyl, 65.0 g (0.42 mol) of 2,5-furandicarboxylic acid, 195.7 g (1.92 mol) of acetic anhydride, and 0.030 g of 1-methylimidazole, a solid powder was obtained in the same way as Example A-1.

Then, the obtained powder was heated from room temperature to 220° C. over a period of 1 hour under nitrogen atmosphere, heated from 220° C. to 250° C. over a period of 3 hours and held at 250° C. for 5 hours to proceed with the polymerization reaction in solid phase to obtain a polyester (A-5). The flow starting temperature of the obtained polyester (A-5) was 301° C. The obtained polyester (A-5) was evaluated in the same way as Example A-1. The results are shown in Table 2.

### Example A-6

Except for changing the components added to the reactor to 508.1 g (2.70 mol) of 2-hydroxy-6-naphthoic acid, 732.0 g (5.30 mol) of p-hydroxybenzoic acid, 113.4 g (1.03 mol (0.03 mol used in excess)) of hydroquinone, 156.1 g (1.00 mol) of 2,5-furandicarboxylic acid, 1181.1 g (11.57 mol) of acetic anhydride, and 0.151 g of 1-methylimidazole, a solid powder was obtained in the same way as Example A-1.

Then, the obtained powder was heated from room temperature to 190° C. over a period of 1 hour under nitrogen atmosphere, heated from 190° C. to 220° C. over a period of 3 hours and held at 220° C. for 5 hours to proceed with the polymerization reaction in solid phase to obtain a polyester (A-6). The flow starting temperature of the obtained polyester (A-6) was 218° C. The obtained polyester (A-6) was evaluated in the same way as Example A-1. The results are shown in Table 2.

### Example A-7

Except for changing the components added to the reactor to 940.9 g (5.00 mol) of 2-hydroxy-6-naphthoic acid, 465.5 g (2.50 mol) of 4,4′-dihydroxybiphenyl, 216.2 g (1.00 mol) of 2,6-naphthalenedicarboxylic acid, 234.1 g (1.50 mol) of 2,5-furandicarboxylic acid, 1174.0 g (11.50 mol) of acetic anhydride, and 0.186 g of 1-methylimidazole, a solid powder was obtained in the same way as Example A-1.

Then, the obtained powder was heated from room temperature to 210° C. over a period of 1 hour under nitrogen atmosphere, heated from 210° C. to 240° C. over a period of 3 hours and held at 240° C. for 5 hours to proceed with the polymerization reaction in solid phase to obtain a polyester (A-7). The flow starting temperature of the obtained polyester (A-7) was 248° C. The obtained polyester (A-7) was evaluated in the same way as Example A-1. The results are shown in Table 2.

### Example A-8

Except for changing the components added to the reactor to 1035.0 g (5.50 mol) of 2-hydroxy-6-naphthoic acid, 255.2 g (2.32 mol (0.07 mol used in excess)) of hydroquinone, 367.5 g (1.70 mol) of 2,6-naphthalenedicarboxylic acid, 7.8 g (0.05 mol) of 2,5-furandicarboxylic acid, 83.1 g (0.50 mol) of terephthalic acid, 1189.9 g (11.65 mol) of acetic anhydride, and 0.175 g of 1-methylimidazole, a solid powder was obtained in the same way as Example A-1.

Then, the obtained powder was heated from room temperature to 250° C. over a period of 1 hour under nitrogen atmosphere, heated from 250° C. to 280° C. over a period of 3 hours and held at 280° C. for 5 hours to proceed with the polymerization reaction in solid phase to obtain a polyester (A-8). The flow starting temperature of the obtained polyester (A-8) was 306° C. The obtained polyester (A-8) was evaluated in the same way as Example A-1. The results are shown in Table 2.

### Example A-9

Except for changing the components added to the reactor to 1035.0 g (5.50 mol) of 2-hydroxy-6-naphthoic acid, 255.2 g (2.32 mol (0.07 mol used in excess)) of hydroquinone, 335.1 g (1.55 mol) of 2,6-naphthalenedicarboxylic acid, 31.2 g (0.20 mol) of 2,5-furandicarboxylic acid, 83.1 g (0.50 mol) of terephthalic acid, 1189.9 g (11.65 mol) of acetic anhydride, and 0.175 g of 1-methylimidazole, a solid powder was obtained in the same way as Example A-1.

Then, the obtained powder was heated from room temperature to 240° C. over a period of 1 hour under nitrogen atmosphere, heated from 240° C. to 270° C. over a period of 3 hours and held at 270° C. for 5 hours to proceed with the polymerization reaction in solid phase to obtain a polyester (A-9). The flow starting temperature of the obtained polyester (A-9) was 298° C. The obtained polyester (A-9) was evaluated in the same way as Example A-1. The results are shown in Table 2.

### Comparative Example B-1

Except for changing the components added to the reactor to 1035.0 g (5.50 mol) of 2-hydroxy-6-naphthoic acid, 255.2 g (2.32 mol (0.07 mol used in excess)) of hydroquinone, 83.1 g (0.50 mol) of terephthalic acid, 378.3 g (1.75 mol) of 2,6-naphthalenedicarboxylic acid, 1189.9 g (11.66 mol) of acetic anhydride, and 0.175 g of 1-methylimidazole, a solid powder was obtained in the same way as Example A-1.

Then, the obtained powder was heated from room temperature to 260° C. over a period of 1 hour under nitrogen atmosphere, heated from 260° C. to 280° C. over a period of 3 hours and held at 280° C. for 5 hours to proceed with the polymerization reaction in solid phase to obtain a polyester (B-1). The flow starting temperature of the obtained polyester (B-1) was 317° C. The obtained polyester (B-1) was evaluated in the same way as Example A-1. The results are shown in Table 3.

### Comparative Example B-2

Except for changing the components added to the reactor to 1129.1 g (6.00 mol) of 2-hydroxy-6-naphthoic acid, 113.4 g (1.03 mol (0.03 mol used in excess)) of hydroquinone, 186.2 g (1.00 mol) of 4,4′-dihydroxybiphenyl, 432.4 g (2.00 mol) of 2,6-naphthalenedicarboxylic acid, 1181.1 g (11.57 mol) of acetic anhydride, and 0.186 g of 1-methylimidazole, a solid powder was obtained in the same way as Example A-1.

Then, the obtained powder was heated from room temperature to 240° C. over a period of 1 hour under nitrogen atmosphere, heated from 240° C. to 270° C. over a period of 3 hours and held at 270° C. for 5 hours to proceed with the polymerization reaction in solid phase to obtain a polyester (B-2). The flow starting temperature of the obtained polyester (B-2) was 270° C. The obtained polyester (B-2) was evaluated in the same way as Example A-1. The results are shown in Table 3.

### Comparative Example B-3

Except for changing the components added to the reactor to 1129.1 g (6.00 mol) of 2-hydroxy-6-naphthoic acid, 113.4 g (1.03 mol (0.03 mol used in excess)) of hydroquinone, 186.2 g (1.00 mol) of 4,4′-dihydroxybiphenyl, 332.3 g (2.00 mol) of terephthalic acid, 1181.1 g (11.57 mol) of acetic anhydride, and 0.186 g of 1-methylimidazole, a solid powder was obtained in the same way as Example A-1.

Then, the obtained powder was heated from room temperature to 220° C. over a period of 1 hour under nitrogen atmosphere, heated from 220° C. to 250° C. over a period of 3 hours and held at 250° C. for 5 hours to proceed with the polymerization reaction in solid phase to obtain a polyester (B-3). The flow starting temperature of the obtained polyester (B-3) was 250° C. The obtained polyester (B-3) was evaluated in the same way as Example A-1. The results are shown in Table 3.

### Comparative Example B-4

Except for changing the components added to the reactor to 903.3 g (4.80 mol) of 2-hydroxy-6-naphthoic acid, 27.6 g (0.20 mol) of p-hydroxybenzoic acid, 465.5 g (2.50 mol) of 4,4′-dihydroxybiphenyl, 415.3 g (2.50 mol) of terephthalic acid, 1174.0 g (11.50 mol) of acetic anhydride, and 0.181 g of 1-methylimidazole, a solid powder was obtained in the same way as Example A-1.

Then, the obtained powder was heated from room temperature to 270° C. over a period of 1 hour under nitrogen atmosphere, heated from 270° C. to 300° C. over a period of 3 hours and held at 300° C. for 5 hours to proceed with the polymerization reaction in solid phase to obtain a polyester (B-4). The flow starting temperature of the obtained polyester (B-4) was 312° C. The obtained polyester (B-4) was evaluated in the same way as Example A-1. The results are shown in Table 4.

### Comparative Example B-5

Except for changing the components added to the reactor to 131.7 g (0.70 mol) of 2-hydroxy-6-naphthoic acid, 357.3 g (3.24 mol (0.09 mol used in excess)) of hydroquinone, 491.7 g (3.15 mol) of 2,5-furandicarboxylic acid, 844.0 g (8.27 mol) of acetic anhydride, and 0.100 g of 1-methylimidazole, a solid powder was obtained in the same way as Example A-1.

Then, the obtained powder was heated from room temperature to 230° C. over a period of 1 hour under nitrogen atmosphere, heated from 230° C. to 240° C. over a period of 3 hours and held at 240° C. for 5 hours to proceed with the polymerization reaction in solid phase to obtain a polyester (B-5). The flow starting temperature of the obtained polyester (B-5) was 250° C. The obtained polyester (B-5) was evaluated in the same way as Example A-1. However, as it was difficult to press form the polyester (B-5), it was not possible to prepare a formed product for an evaluation of dielectric properties, and it was not possible to evaluate the dielectric properties. The results are shown in Table 4.

### Comparative Example B-6

Except for changing the components added to the reactor to 828.7 g (6.00 mol) of p-hydroxybenzoic acid, 372.4 g (2.00 mol) of 4,4′-dihydroxybiphenyl, 249.2 g (1.50 mol) of terephthalic acid, 83.1 g (0.50 mol) of isophthalic acid, 1174.0 g (11.50 mol) of acetic anhydride, and 0.153 g of 1-methylimidazole, a solid powder was obtained in the same way as Example A-1.

Then, the obtained powder was heated from room temperature to 260° C. over a period of 1 hour under nitrogen atmosphere, heated from 260° C. to 280° C. over a period of 3 hours and held at 280° C. for 5 hours to proceed with the polymerization reaction in solid phase to obtain a polyester (B-6). The flow starting temperature of the obtained polyester (B-6) was 316° C. The polyester (B-6) was evaluated in the same way as Example A-1. The results are shown in Table 4.

In Tables 1 to 4, “1-3-1” represents 2,5-furandicarboxylic acid; “1-1-2” represents 2-hydroxy-6-naphthoic acid; “1-3-2” represents 2,6-naphthalenedicarboxylic acid; “1-1-3” represents p-hydroxybenzoic acid; “1-2-3-1” represents hydroquinone; “1-2-3-2” represents 4,4′-dihydroxybiphenyl; “1-3-3-1” represents terephthalic acid; and “1-3-3-2” represents isophthalic acid. The numerical value corresponding to each component in Tables 1 to 4 represents a percentage (mol %) of each component based on the total amount of monomers forming the polyester.

TABLE 1

| | | Example | | | |
|---|---|---|---|---|---|
| | | A-1 | A-2 | A-3 | A-4 |
| First monomer | 1-3-1 | 5 | 5 | 20 | 30 |
| Second | 1-1-2 | 60 | 55 | 60 | 40 |
| monomer | 1-3-2 | — | 17.5 | — | — |
| Third monomer | 1-1-3 | — | — | — | — |
| | 1-2-3-1 | — | 22.5 | 10 | 15 |
| | 1-2-3-2 | 20 | — | 10 | 15 |
| | 1-3-3-1 | 15 | — | — | — |
| | 1-3-3-2 | — | — | — | — |

| | | | | |
|---|---|---|---|---|
| Flow starting | 327 | 324 | 239 | 244 |
| temperature (° C.) | | | | |
| Formability | B | A | A | A |
| 5% weight loss | 487 | 481 | 462 | 463 |
| temperature (° C.) | | | | |
| Relative permittivity | 3.2 | 2.9 | 3.6 | 3.5 |
| Dielectric loss tangent | 0.0015 | 0.0012 | 0.0026 | 0.0045 |

TABLE 2

| | | Example | | | | |
|---|---|---|---|---|---|---|
| | | A-5 | A-6 | A-7 | A-8 | A-9 |
| First monomer | 1-3-1 | 25 | 10 | 15 | 0.5 | 2 |
| Second monomer | 1-1-2 | 48 | 27 | 50 | 55 | 55 |
| | 1-3-2 | — | — | 10 | 17 | 15.5 |
| Third monomer | 1-1-3 | 2 | 53 | — | — | — |
| | 1-2-3-1 | — | 10 | — | 22.5 | 22.5 |
| | 1-2-3-2 | 25 | — | 25 | — | — |
| | 1-3-3-1 | — | — | — | 5 | 5 |
| | 1-3-3-2 | — | — | — | — | — |

| | | | | | |
|---|---|---|---|---|---|
| Flow starting temperature (° C.) | 301 | 218 | 248 | 306 | 298 |
| Formability | B | A | A | A | A |
| 5% weight loss temperature (° C.) | 463 | 464 | 458 | 500 | 495 |
| Relative permittivity | 3.3 | 3.5 | 3.4 | 3.3 | 3.3 |
| Dielectric loss tangent | 0.0042 | 0.0031 | 0.0030 | 0.0010 | 0.0012 |

TABLE 3

| | | Comparative Example | | |
|---|---|---|---|---|
| | | B-1 | B-2 | B-3 |
| First monomer | 1-3-1 | — | — | — |
| Second monomer | 1-1-2 | 55 | 60 | 60 |
| | 1-3-2 | 17.5 | 20 | — |
| Third monomer | 1-1-3 | — | — | — |
| | 1-2-3-1 | 22.5 | 10 | 10 |
| | 1-2-3-2 | — | 10 | 10 |
| | 1-3-3-1 | 5 | — | 20 |
| | 1-3-3-2 | — | — | — |

| | | | |
|---|---|---|---|
| Flow starting temperature (° C.) | 317 | 270 | 250 |
| Formability | C | C | D |
| 5% weight loss temperature (° C.) | 501 | 483 | 500 |
| Relative permittivity | 3.2 | 3.3 | 3.1 |
| Dielectric loss tangent | 0.0009 | 0.0012 | 0.0015 |

TABLE 4

| | | Comparative Example | | |
|---|---|---|---|---|
| | | B-4 | B-5 | B-6 |
| First monomer | 1-3-1 | — | 45 | — |
| Second monomer | 1-1-2 | 48 | 10 | — |
| | 1-3-2 | — | — | — |
| Third monomer | 1-1-3 | 2 | — | 60 |
| | 1-2-3-1 | — | 45 | — |
| | 1-2-3-2 | 25 | — | 20 |
| | 1-3-3-1 | 25 | — | 15 |
| | 1-3-3-2 | — | — | 5 |

| | | | |
|---|---|---|---|
| Flow starting temperature (° C.) | 312 | 250 | 316 |
| Formability | C | D | C |
| 5% weight loss temperature (° C.) | 512 | 355 | 511 |
| Relative permittivity | 3.2 | — | 3.5 |
| Dielectric loss tangent | 0.0013 | — | 0.0028 |

1. A polyester, comprising:
a first monomeric unit derived from a first monomer having a furan ring with two carbonyl groups attached; and
a second monomeric unit having a condensed aromatic ring,
wherein a content of the first monomeric unit is 0.1 mol % or more and 40 mol % or less based on the total of all monomeric units; and
a content of the second monomeric unit is 20 mol % or more based on the total of all monomeric units.

2. The polyester according to claim 1, wherein 90 mol % or more of monomeric units based on the total of all monomeric units is a monomeric unit having an aromatic ring.

3. The polyester according to claim 1, further comprising a third monomeric unit having a benzene ring but no condensed aromatic ring or furan ring.

4. The polyester according to claim 3, wherein a content of the third monomeric unit is 10 mol % or more and 75 mol % or less based on the total of all monomeric units.

5. The polyester according to claim 1, wherein the polyester has a 5% weight loss temperature of 450° C. or more.

6. A formed product comprising the polyester according to claim 1.

7. A method for manufacturing a formed product, comprising a step of molding a raw molding material containing the polyester according to claim 1 to obtain the molded product.

8. The method for manufacturing according to claim 7, wherein the step is a step for press molding the raw material for molding.
